(19) United States
(12) Patent Application Publication
(10) Pub. No.: US 2006/0107496 A1
(43) Pub. Date: May 25, 2006

(54) Paper clip with double clipping effect

(75) Inventor: Chen-Chia Cheng, Tsoying (TW)

Correspondence Address: BIRCH STEWART KOLASCH & BIRCH, PO BOX 747, FALLS CHURCH, VA, 22040-0747, US

(73) Assignee: Hui-Mei Guo

(21) Appl. No.: 11/195,677

(22) Filed: Aug. 3, 2005

(30) Foreign Application Priority Data
Nov. 22, 2004 (TW) 093218674

(51) Int. Cl. B42F 1/02

(52) U.S. Cl. 24/67.9

(57) ABSTRACT

A paper clip includes a common section, a first clipping section extending from and integral with an end of the common section, and a second clipping section extending from and integral with the other end of the common section. Preferably, the first clipping section and the second clipping section are diagonally symmetric with respect to the common section. Preferably, each of the first clipping section and the second clipping section includes in sequence a first bend, a first leg, a second bend, a second leg, a third bend, and a third leg, forming an outer loop and an inner loop inside the outer loop. A clipping space is defined between the inner loop and the outer loop of each of the first clipping section and the second clipping section. A double clipping effect is thus provided.

### BACKGROUND OF THE INVENTION

1. Field of the Invention

The present invention relates to a clip. In particular, the present invention relates to a paper clip.

2. Description of the Related Art

A paper clip is generally used to clip papers or other articles. Nevertheless, it is not uncommon that the papers could not be securely clipped by a single paper clip. As a result, one or more additional paper clips are required, which is not efficient and incurs additional cost.

### SUMMARY OF THE INVENTION

It is therefore an objective of the present invention to provide a paper clip with a double clipping effect for reliably clipping papers or other articles.

A paper clip in accordance with the present invention comprises a common section including a first end and a second end, a first clipping section extending from and integral with the first end of the common section, and a second clipping section extending from and integral with the second end of the common section.

Preferably, the first clipping section and the second clipping section are diagonally symmetric with respect to the common section.

Preferably, each of the first clipping section and the second clipping section comprises in sequence a first bend, a first leg, a second bend, a second leg, a third bend, a third leg, a fourth bend, and a fourth leg, forming an outer loop and an inner loop inside the outer loop.

Preferably, each of the outer loop and the inner loop of each of the first clipping section and the second clipping section is substantially rectangular, triangular, circular, or irregular.

A space is defined between the inner loop and the outer loop of each of the first clipping section and the second clipping section for clipping papers or other articles. A double clipping effect is thus provided and disengagement of the paper clip from the papers or articles would not occur.

Other objectives, advantages, and novel features of the invention will become more apparent from the following detailed description when taken in conjunction with the accompanying drawings.

### BRIEF DESCRIPTION OF THE DRAWINGS

FIG. 1 is a perspective view illustrating formation of an embodiment of a paper clip in accordance with the present invention.

FIG. 2 is a top plane view of the paper clip in FIG. 1.

FIG. 3 is a top plane view of another embodiment of the paper clip in accordance with the present invention.

FIG. 4 is a schematic view illustrating use of the paper clip in accordance with the present invention.

### DETAILED DESCRIPTION OF THE PREFERRED EMBODIMENTS

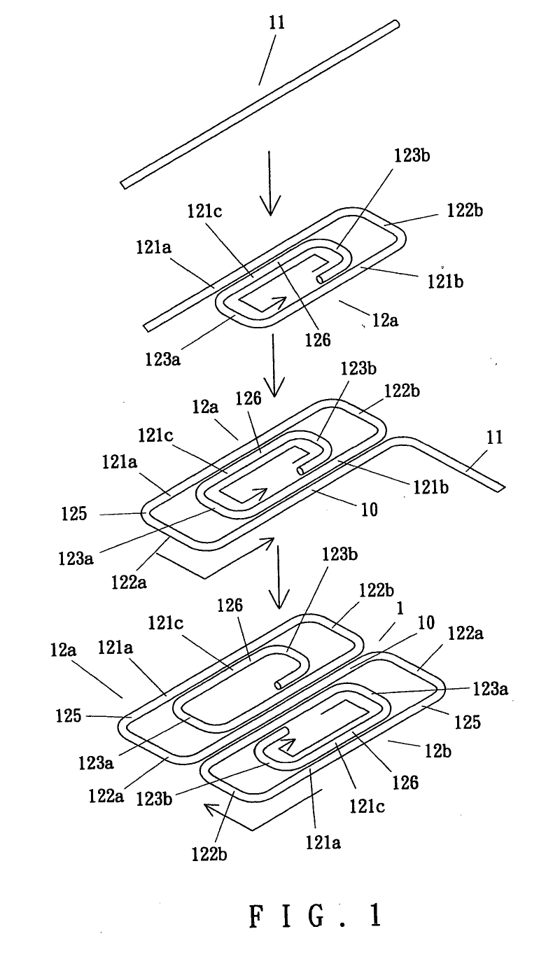

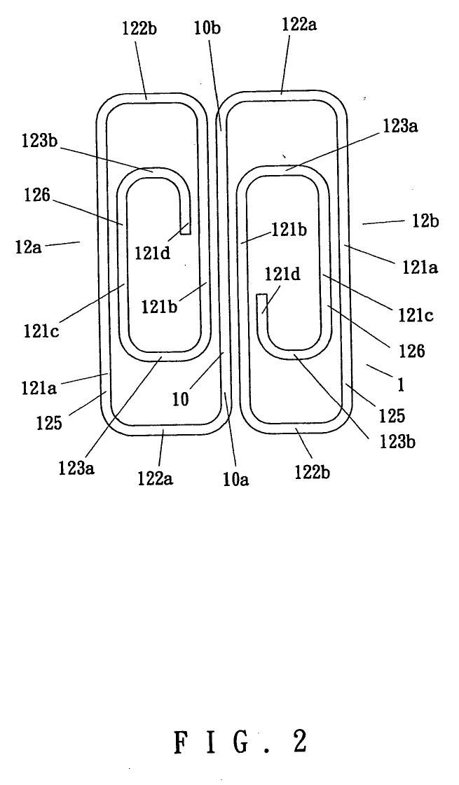

FIG. 1 is a perspective view illustrating formation of an embodiment of a paper clip 1 in accordance with the present invention. FIG. 2 is a top plane view of the paper clip 1 in FIG. 1.

The paper clip 1 is formed by bending a wire 11 made of metal or alloy. As illustrated in FIG. 1, the wire 11 is bent to form a first clipping section 12a at a side of a common section 10. The wire 11 is further bent to form a second clipping section 12b at the other side of the common section 10.

Referring to FIG. 2, the resultant paper clip 1 in accordance with the present invention comprises a common section 10 including a first end 10a and a second end 10b, a first clipping section 12a extending from and integral with the first end 10a of the common section 10, and a second clipping section 12b extending from and integral with the second end 10b of the common section 10.

Preferably, the first clipping section 12a and the second clipping section 12b are diagonally symmetric with respect to the common section 10.

In the illustrated embodiment, each of the first clipping section 12a and the second clipping section 12b comprises in sequence a first bend 122a, a first leg 121a, a second bend 122b, a second leg 121b, a third bend 123a, a third leg 121c, a fourth bend 123b, and a fourth leg 121d, forming an outer loop 125 and an inner loop 126 inside the outer loop 125.

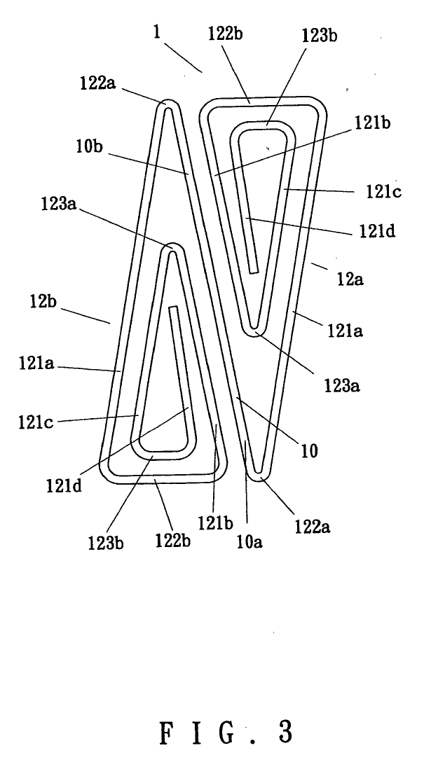

In the embodiment illustrated in FIG. 2, each of the outer loop 125 and the inner loop 126 of each of the first clipping section 12a and the second clipping section 12b is substantially rectangular. Nevertheless, each of the outer loop 125 and the inner loop 126 of each of the first clipping section 12a and the second clipping section 12b may be triangular (see FIG. 3), circular, or irregular.

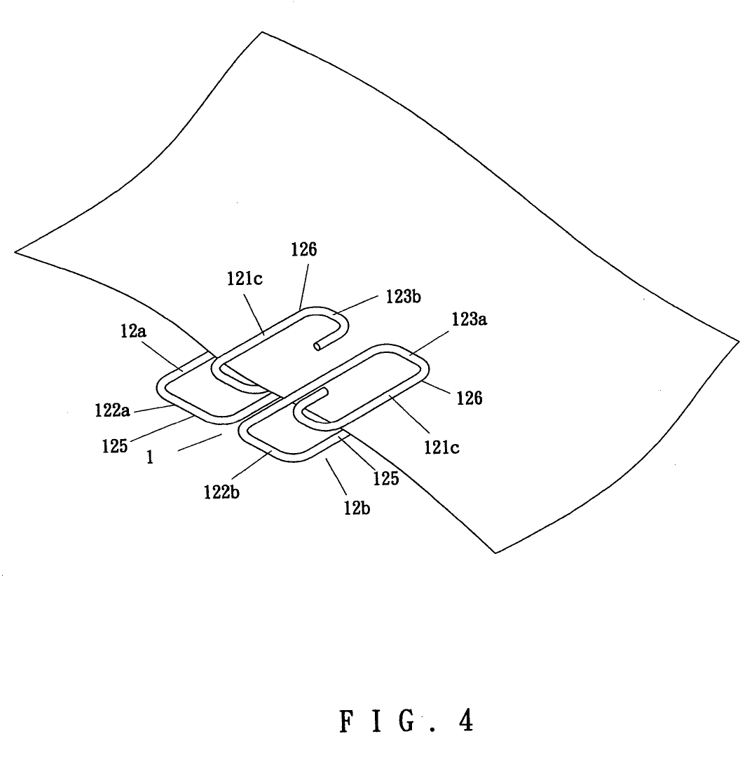

FIG. 4 shows use of the paper clip 1. It is noted that a space is defined between the inner loop 126 and the outer loop 125 of each of the first clipping section 12a and the second clipping section 12b for clipping papers or other articles. A double clipping effect is thus provided and disengagement of the paper clip 1 from the papers or articles would not occur.

It is noted that the paper clip 1 can be made of other suitable material such as plastics. Further, the paper clip 1 can be formed by other suitable methods.

Although specific embodiments have been illustrated and described, numerous modifications and variations are still possible without departing from the essence of the invention. The scope of the invention is limited by the accompanying claims.

What is claimed is:

1. A paper clip comprising:
a common section including a first end and a second end;
a first clipping section extending from and integral with the first end of the common section; and
a second clipping section extending from and integral with the second end of the common section.

2. The paper clip as claimed in claim 1, wherein the first clipping section and the second clipping section are diagonally symmetric with respect to the common section.

3. The paper clip as claimed in claim 1, wherein the first clipping section comprises in sequence a first bend, a first leg, a second bend, a second leg, a third bend, a third leg, a fourth bend, and a fourth leg, forming an outer loop and an inner loop inside the outer loop.

4. The paper clip as claimed in claim 3, wherein each of the outer loop and the inner loop of the first clipping section is substantially one of triangular, rectangular, circular, and irregular.

5. The paper clip as claimed in claim 2, wherein the first clipping section comprises in sequence a first bend, a first leg, a second bend, a second leg, a third bend, a third leg, a fourth bend, and a fourth leg, forming an outer loop and an inner loop inside the outer loop.

6. The paper clip as claimed in claim 5, wherein each of the outer loop and the inner loop of the first clipping section is substantially one of triangular, rectangular, circular, and irregular.

7. The paper clip as claimed in claim 1, wherein the second clipping section comprises in sequence a first bend, a first leg, a second bend, a second leg, a third bend, a third leg, a fourth bend, and a fourth leg, forming an outer loop and an inner loop inside the outer loop.

8. The paper clip as claimed in claim 7, wherein each of the outer loop and the inner loop of the first clipping section is substantially one of triangular, rectangular, circular, and irregular.

9. The paper clip as claimed in claim 2, wherein the second clipping section comprises in sequence a first bend, a first leg, a second bend, a second leg, a third bend, a third leg, a fourth bend, and a fourth leg, forming an outer loop and an inner loop inside the outer loop.

10. The paper clip as claimed in claim 9, wherein each of the outer loop and the inner loop of the first clipping section is substantially one of triangular, rectangular, circular, and irregular.
